(19) United States
(12) Patent Application Publication
(10) Pub. No.: US 2026/0316046 A1
(43) Pub. Date: Oct. 15, 2026

(54) MONOLITHIC SUBSTRATE WITH MULTIMODAL PORE SIZE DISTRIBUTION

(71) Applicant: CORNING INCORPORATED, CORNING, NY (US)

(72) Inventors: Douglas Munroe Beall, Painted Post, NY (US); David John Thompson, Savona, NY (US)

(21) Appl. No.: 19/484,449

(22) PCT Filed: May 1, 2024
(86) PCT No.: PCT/US2024/027121

§ 371 Date: Nov. 14, 2025

Related U.S. Application Data
(60) Provisional application No. 63/467,369, filed on May 18, 2023.

(51) Int. Cl. B01J 20/10; B01J 20/08; B01J 20/28

(52) U.S. Cl. CPC B01J 20/103; B01J 20/08; B01J 20/28011; B01J 20/28045; B01J 20/28069; B01J 20/28085

(57) ABSTRACT

A particulate filter and method of manufacture. The particulate filter comprises a ceramic honeycomb body comprising a plurality of intersecting walls that define a plurality of channels extending longitudinally though the ceramic honeycomb body. The intersecting walls comprise a porous ceramic material having a microstructure that comprises an interconnected network of porous spheroidal ceramic beads. The microstructure has a total porosity defined as the sum of an open intrabead porosity of the beads and an interbead porosity defined by interstices between the beads in the interconnected network. The microstructure has a bimodal pore size distribution in which an intrabead median pore size of the intrabead porosity is from 1.5 μm to 4 μm and an interbead median pore size of the interbead porosity is from 6 μm to 20 μm.

### CROSS-REFERENCE TO RELATED APPLICATIONS

This application claims the benefit of priority under 35 U.S.C. § 119 of U.S. Provisional Application Ser. No. 63/467,369 filed on May 18, 2023, the content of which is relied upon and incorporated herein by reference in its entirety.

### BACKGROUND

One method of removing CO₂ from a gas, either from a point source or from ambient air includes flowing a CO₂ laden stream through a monolith containing a sorbent that adsorbs the CO₂. The CO₂ can later be desorbed for removal (e.g., via heating of the monolith). Similarly, exhaust emissions or other fluid streams, can undergo pollution abatement or otherwise be treated by flowing the fluid stream through a catalyst-coated monolith.

To coat conventional substrates with a functional material such as a catalyst or sorbent, a high surface area material may be applied to the substrate in the form of a slurry which is later dried and calcined to form a ceramic washcoat. A common example of such a high surface area material is gamma alumina. A catalyst or sorbent material can be applied (coated) along with or onto the high surface area material in order to enable the coated substrate to treat exhaust emissions, capture CO₂, or serve another purpose or function.

### SUMMARY OF THE INVENTION

In various aspects, the present disclosure provides a monolithic substrate. The monolithic substrate includes a ceramic and/or glass matrix that includes first pores and second pores. The first pores have a size of ≥0.1 micron to <1 micron and the second pores have a size of ≥1 micron to ≤30 microns. The first pores and the second pores are each at least 5% of a total pore volume of the monolithic substrate. The total pore volume of the monolithic substrate is greater than or equal to 40% by volume as determined by mercury porosimetry.

In various aspects, the present disclosure provides a monolithic substrate. The monolithic substrate includes a ceramic and/or glass matrix that includes a continuous interconnected pore structure that include first pores and second pores. The first pores have a size of ≥0.1 micron to <1 micron and a local maximum differential intrusion as determined via mercury porosimetry at a pore size of 0.1 microns to 0.9 microns. The second pores have a size of ≥1 micron to ≤30 microns and a local maximum differential intrusion as determined via mercury porosimetry at a pore size of 1.5 microns to 10 microns. The first pores are 10% to 94% of a total pore volume of the monolithic substrate and the second pores are 6% to 90% of the total pore volume. In some aspects, the total pore volume of the monolithic substrate is greater than or equal to 60% to 75% by volume as determined by mercury porosimetry. The monolithic substrate also includes a coating including a catalyst, a sorbent that adsorbs and desorbs CO₂, or a combination thereof. The coating is directly adhered to the glass and/or ceramic matrix. The monolithic substrate is free of a bonding layer between the coating and the glass and/or ceramic matrix.

In various aspects, the monolithic substrate includes an extruded, dried, and fired product of an extrudable composition. The extrudable composition includes a binder and/or sintering aid. The extrudable composition also includes a particulate material for forming the first pores and that is stable to firing at a temperature of at least 600° C.

In various aspects, the present disclosure provides a monolithic substrate that includes an extruded, dried, and fired product of an extruded extrudable composition. The extrudable composition includes a binder and/or sintering aid. The extrudable composition also includes a particulate material for forming the first pores and that is stable to firing at a temperature of at least 600° C. The monolithic substrate includes a ceramic and/or glass matrix including a continuous interconnected pore structure that includes first pores and second pores. The first pores have a size of >0.1 micron to <1 micron and the second pores have a size of ≥1 micron to ≤30 microns. The first pores and the second pores are each at least 5% of a total pore volume of the monolithic substrate. The total pore volume of the monolithic substrate is greater than or equal to 40% by volume as determined by mercury porosimetry.

In various aspects, the present disclosure provides a method of forming the monolithic substrate. The method includes extruding the extrudable composition. The method includes drying the extruded composition. The method also includes firing the dried extruded composition, to form the monolithic substrate.

In various aspects, the present disclosure provides a method of forming a monolithic substrate. The method includes extruding an extrudable composition. The extrudable composition includes a binder and/or sintering aid. The extrudable composition also includes a particulate material for forming first pores and that is stable to firing at a temperature of at least 600° C. The method includes drying extruded composition. The method also includes firing the dried extruded composition, to form the monolithic substrate. The monolithic substrate includes a ceramic and/or glass matrix including a continuous interconnected pore structure that includes the first pores and second pores. The first pores have a size of ≥0.1 micron to <1 micron and the second pores have a size of ≥1 micron to ≤30 microns. The first pores and the second pores are each at least 5% of a total pore volume of the monolithic substrate. The total pore volume of the monolithic substrate is greater than or equal to 40% by volume as determined by mercury porosimetry.

In various aspects, the present disclosure provides a method of using the monolithic substrate that includes a coating including a sorbent that adsorbs and desorbs CO₂. The method includes exposing the monolithic substrate to a gas stream including CO₂ to at least partially adsorb the CO₂ from the gas stream into the coating on the monolithic substrate. The method also includes desorbing the CO₂ from the coating on the monolithic substrate.

In conventional monoliths, a washcoat adds a significant amount of thermal mass to the substrate, requiring excess heat energy to be put into the system for CO₂ desorption and slowing the return to lower temperatures after desorption to resume the adsorption operation. The application of washcoat to the walls of the channels results in a reduction in the hydraulic diameter of the channels which increases the pressure drop across the substrate, thereby increasing the energy needed to move a particular volume of air through the substrate. The coating step also adds cost to the final product. Further, the amount of sorbent that can be used is limited to the amount of washcoat that is be applied. In various aspects, the monolithic substrate of the present disclosure including a multimodal pore distribution including first pores and second pores can be effectively coated with a coating including a sorbent that adsorbs and desorbs CO₂ more easily and more effectively than other monolithic substrates. For example, in various aspects, the monolithic substrate of the present disclosure can be effectively coated with a coating including a sorbent without the use of an intervening washcoat layer (e.g., instead of requiring application of a washcoat layer, which can include fine pores, the monolithic substrate can already include sufficient fine pores and can therefore be “sorbent-ready”).

In various aspects, during coating with a coating including a sorbent and/or catalyst, the sorbent and/or catalyst can enter the continuous interconnected pores structure via the coarse pores (e.g., second pores), and then be concentrated into the fine pore structure (e.g., first pores) of the monolithic substrate. Various aspects of the monolithic substrate of the present disclosure can have a lower pressure drop across the substrate as compared to monolithic substrates lacking a coarse pore structure, such as due to the ease with which gas can be transported through the course pores and/or due to the substrate being free of a washcoat to support the sorbent which avoids the constriction that can be caused from added washcoat. In various aspects, the presence of the first and second pores in the monolithic substrate of the present disclosure can provide an advantageous combination of high surface area for sorbent coating along with good gas diffusion characteristics through the monolithic substrate. In various aspects, by avoiding an intervening layer between the monolithic substrate and the sorbent coating, the monolithic substrate can be manufactured with less expense, the monolithic substrate of the present disclosure can avoid additional thermal mass and added bulk density from an intervening layer, the monolithic substrate can avoid a reduction in hydraulic diameter of channels in the monolithic substrate from an intervening layer, the monolithic substrate can be coated with a greater quantity of sorbent (e.g., not limited to locations that include an intervening layer), the monolithic substrate can have a greater overall CO₂ capture and/or catalytic capacity, or a combination thereof.

### BRIEF DESCRIPTION OF THE FIGURES

The drawings illustrate generally, by way of example, but not by way of limitation, various aspects of the present disclosure.

FIG. 1 illustrates a SEM micrograph of a polished section of a ceramic matrix formed from a composition including talc, a sintering aid, and cross-linked pea starch, in accordance with various aspects.

FIG. 2A illustrates cumulative intrusion versus pore size diameter of the ceramic substrate shown in FIG. 1 as measured during mercury porosimetry testing, in accordance with various aspects.

FIG. 2B illustrates differential intrusion versus pore size diameter of the ceramic substrate shown in FIG. 1 as measured during mercury porosimetry testing, in accordance with various aspects.

FIG. 3A illustrates a SEM micrograph of diatomaceous earth particles, in accordance with various aspects.

FIG. 3B illustrates a SEM micrograph of diatomaceous earth particles, in accordance with various aspects.

FIG. 4A-B illustrate SEM micrographs of a polished cross section of a composition including diatomaceous earth, talc, sintering aid, and cross-linked pea starch after firing, in accordance with various aspects.

FIG. 5A-C illustrate differential intrusion versus pore size distribution as measured during mercury porosimetry testing for fired ceramic matrices including various proportions of diatomaceous earth and cross-linked pea starch, in accordance with various aspects.

FIGS. 6A-B illustrate differential intrusion versus pore size distribution as measured during mercury porosimetry testing for fired ceramic matrices including various types of diatomaceous earth with cross-linked pea starch, in accordance with various aspects.

FIG. 7A illustrates cumulative intrusion versus pore size diameter of a substrate having a trimodal pore size distribution as measured during mercury porosimetry testing, in accordance with various aspects.

FIG. 7B illustrates differential intrusion versus pore size diameter of a substrate having a trimodal pore size distribution as measured during mercury porosimetry testing, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “and/or” as used herein means the stated possibilities in the alternative or any combination thereof. For example, “A, B, and/or C” means A, B, C, or a combination thereof.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 0.1 wt % of the composition is the material, or about 0 wt % to about 0.01 wt %, or about 0.1 wt % or less, or less than, equal to, or greater than about 0.9 wt %, 0.8, 0.7, 0.6, 0.5, 0.4, 0.3, 0.2, 0.1, 0.08, 0.06, 0.04, 0.02, 0.01, or about 0.001 wt % or less, or about 0 wt %.

### Monolithic Substrate.

Various aspects of the present disclosure provide a monolithic substrate. The monolithic substrate can include a ceramic and/or glass matrix. The ceramic and/or glass matrix can include a continuous interconnected pore structure that includes first pores and second pores. The first pores can have a size of ≥0.1 micron to <1 micron and the second pores can have a size of ≥1 micron to ≤30 microns, wherein as used herein the pore size for a given type of pore is determined as an assumed spherical median pore diameter via mercury porosimetry. As used herein, the first pores refers to a portion of the pore size distribution having a smaller size than that of the second pores. Accordingly, the first pores may be referred to as fine pores while the second pores may be referred to as coarse pores. The first pores and the second pores can each be at least 5% of a total pore volume of the monolithic substrate. The total pore volume of the monolithic substrate can be greater than or equal to 40% by volume as determined by mercury porosimetry. Mercury porosimetry, such as for determining total pore volume and/or bulk density, can be performed as per ASTM D6761-07 (2012).

The first pores and the second pores can be homogeneously distributed throughout the ceramic and/or glass matrix. The monolithic substrate can be the ceramic and/or glass matrix including the interconnected pore structure including first pores and second pores. The monolithic substrate can optionally include a coating. The coating can include any suitable material, such as a sorbent (e.g., a sorbent that adsorbs and desorbs CO₂), a catalyst (e.g., a catalyst for a catalytic converter, or another catalyst), or a combination thereof. The coating can be continuous or discontinuous. The monolithic substrate can include a bimodal pore size distribution, a trimodal pore size distribution, or a polymodal pore size distribution that is greater than a trimodal pore size distribution.

The monolithic substrate can have any suitable bulk density. Bulk density is the mass of the substrate divided by the total volume that the substrate occupies, wherein the total volume the substrate occupies includes particle volume, inter-particle void volume, and internal pore volume (intraparticle void), but does not include longitudinal channels (e.g., portions of the substrate when viewed from a longitudinal end of the substrate that are considered to be open frontal area). The total volume that a substrate with a honeycomb form occupies can be defined as the portions of the substrate when viewed from a longitudinal end of the substrate that is considered to be closed frontal area (CFA) versus those of the open frontal area (OFA), with the CFA and OFA given as complementary percentages that sum to 100%. In particular, the OF A corresponds to the portions of the cross-sectional area occupied by the open channels of the honeycomb form of the substrate, while the CFA corresponds to the remaining portions occupied by the matrix of intersecting walls. For example, the monolithic substrate (e.g., absent any coatings added thereto) can have a bulk density of less than 1.5 g/cm³, or in the range of 0.5 g/cm³ to 1.15 g/cm³, 0.6 g/cm³ to 0.8 g/cm³, or less than or equal to 1.5 g/cm³ and greater than or equal to 0.5 g/cm³ and less than, equal to, or greater than 0.6, 0.7, 0.8, 0.9, 1, 1.1, 1.2, 1.3, or 1.4 g/cm³. The monolithic substrate (e.g., absent any coatings added thereto) can have any suitable total pore volume, as determined via mercury porosimetry, such as greater than 40%, or in the range of 40% to 80%, 60% to 75%, or less than or equal to 80% and greater than or equal to 40% and less than, equal to, or greater than 42%, 44, 46, 48, 50, 52, 54, 56, 58, 60, 61, 62, 63, 64, 65, 66, 67, 68, 69, 70, 71, 72, 74, 76, or 78%.

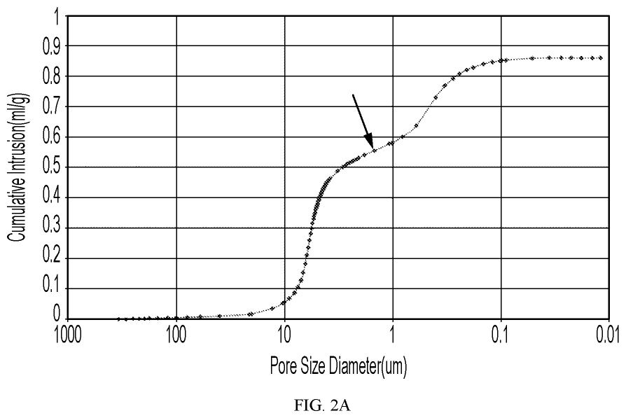

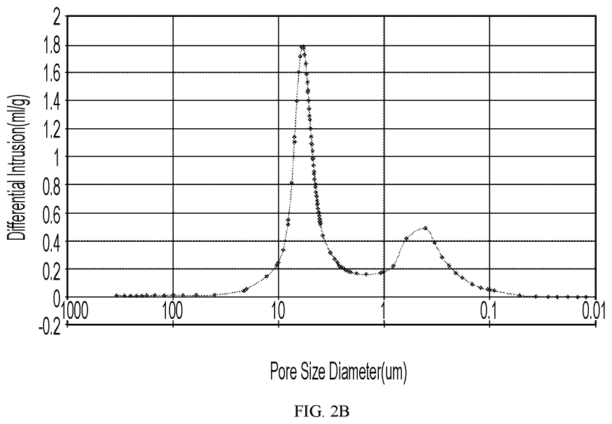

The first pores can have any suitable size, wherein as used herein the pore size for a given type of pore is determined as an assumed spherical pore diameter via mercury porosimetry. As described in more detail herein, the first and second pores can be recognized by corresponding peaks in the plotted differential intrusion data gathered by mercury porosimetry. Accordingly, the size of the first and second pores, as referred to herein, can be determined as the pore size on the differential intrusion plot that corresponds to the maximum intrusion value for each peak in the plot. For example, as described in more detail below with respect to Example 1 disclosed herein, FIG. 2B illustrates a pore size distribution that has two peaks corresponding to the first pores and the second pores of the monolith made in accordance with Example 1, where the size of the first pores is approximately 0.4 μm and the size of the second pores is approximately 8 μm.

The first pores can have a size of ≥0.1 micron to <1 micron, or ≥0.1 microns to ≤0.9 microns, or less than or equal to 1 micron and greater than or equal to 0.1 microns and less than, equal to, or greater than 0.2, 0.3, 0.4, 0.5, 0.6, 0.7, 0.8, 0.9, or 0.99 microns. The first pores can have a maximum differential intrusion value (ml/g, as determined via mercury porosimetry) located at any suitable a pore size (e.g., at a pore size within the pore size range of the first pores), such as at a pore size of ≥0.1 micron to <1 micron, or 0.1 microns to 0.9 microns, or less than or equal to 0.9 microns and greater than or equal to 0.1 microns and less than, equal to, or greater than 0.2, 0.3, 0.4, 0.5, 0.6, 0.7, 0.8, 0.9, or 0.99 microns. The maximum differential intrusion value of the first or second pores can be determined mathematically as a local maxima of the corresponding peak in the pore size distribution.

The second pores can have any suitable size that is larger than that of the first pores, such as a size of ≥1 micron to ≤30 microns, or ≥1.5 microns to ≤10 microns, or less than or equal to 30 microns and greater than or equal to 1 micron and less than, equal to, or greater than 1.01 microns, 1.5, 2, 3, 4, 5, 6, 7, 8, 9, 10, 12, 14, 16, 18, 20, 22, 24, 26, or 28 microns. The second pores can have a maximum differential intrusion value (ml/g, as determined via mercury porosimetry) at any suitable pore size (e.g., at a pore size within the pore size range of the second pores), such as at a pore size of ≥1 micron to ≤30 microns, or 1.5 microns to 10 microns, or less than or equal to 10 microns and greater than or equal to 1.5 microns and less than, equal to, or greater than 2 microns, 2.5, 3, 3.5, 4, 4.5, 5, 5.5, 6, 6.5, 7, 7.5, 8, 8.5, 9, 10, 12, 14, 16, 18, 20, 22, 24, 26, or 28 microns. The difference between the maximum differential intrusion value of the first pores and the maximum differential intrusion value of the second pores (when differential intrusion is plotted with respect to pore size as determined via mercury porosimetry) can be ≥0.01 micron to ≤29.9 microns, or 0.5 microns to 10 microns, or less than or equal to 29.9 microns and greater than or equal to 0.01 microns, 0.05, 0.1, 0.2, 0.4, 0.6, 0.8, 1, 2, 2.5, 3, 3.5, 4, 4.5, 5, 5.5, 6, 6.5, 7, 7.5, 8, 8.5, 9, 10, 12, 14, 16, 18, 20, 22, 24, 26, or 28 microns.

The first pores (e.g., as measured absent any coating added to the monolithic substrate) can be any suitable proportion of the total pore volume of the monolithic substrate, such as at least 5% of the total pore volume of the monolithic substrate, or 10% to 94%, or 30% to 55%, or less than or equal to 94% and greater than or equal to 5% and less than, equal to, or greater than 10, 15, 20, 25, 30, 32, 34, 36, 38, 40, 42, 44, 46, 48, 50, 52, 54, 55, 60, 65, 70, 75, 80, 85, or 90%. The second pores (e.g., as measured absent any coating added to the monolithic substrate) can be any suitable proportion of the total pore volume of the monolithic substrate, such as at least 5% of the total pore volume of the monolithic substrate, or 6% to 90%, or 40% to 85%, or less than or equal to 90% and greater than or equal to 5% and less than, equal to, or greater than 6%, 10, 15, 20, 25, 30, 35, 40, 42, 44, 46, 48, 50, 52, 54, 56, 58, 60, 62, 64, 66, 68, 70, 72, 74, 76, 78, 80, 82, 84, or 85%. In various embodiments, the monolithic substrate can be substantially free of pores other than the first and second pores. For example, pores other than the first and second pores can be less than 20% of the total volume of the monolithic substrate, or less than 15%, 10, 9, 8, 7, 6, 5, 4, 3, 2, or less than 1% of the total volume of the monolithic substrate.

The monolithic substrate can have any suitable flexural strength in a 4-point bend test of the monolithic substrate, such as performed per ASTM-D6272. For ease of comparison of honeycomb monoliths having different geometries, the strength can be normalized by the CFA of the monolithic substrate. For example, the monolithic substrate can have a flexural strength in a 4-point bend test of the monolithic substrate normalized by the CFA of the monolithic substrate (i.e., divided by the CFA of the monolithic substrate, given as a percentage) of greater than 500 psi, or in the range of 500 psi to 3000 psi, or 1000 psi to 2600 psi, or less than or equal to 3000 psi and greater than or equal to 500 psi and less than, equal to, or greater than 600 psi, 700, 800, 900, 1000, 1100, 1200, 1300, 1400, 1500, 1600, 1700, 1800, 1900, 2000, 2100, 2200, 2300, 2400, 2500, 2600, 2700, 2800, or 2900 psi.

The monolithic substrate can have any suitable physical form. In various aspects, the physical form is that of a honeycomb form (e.g., an extruded honeycomb form), having a plurality of cells therein, the cells that define parallel channels running longitudinally through the honeycomb form. The cells can be formed by an array or matrix of intersecting walls (e.g., the ceramic and/or glass matrix). The honeycomb form can have any suitable circumferential profile or shape, such as that of a circle, oval, square, rectangle, hexagon, triangle, polygon, or irregular shape. When viewed from an end of the honeycomb form, the cells can have any suitable profile, such as a profile of a circle, oval, square, rectangle, hexagon, triangle, polygon, or irregular shape, such as a honeycomb shape. For example, one possible combination is a cylindrical substrate (circular circumferential profile) that has square-shaped cells. The use of a honeycomb form can advantageously result in a lower pressure drop of a fluid stream flowing from one axial end of the monolith to the other end in comparison to other forms (such as packed pellet beds). The honeycomb form can include any suitable number of cells per square inch (e.g., as measured when viewed from an end), such as 20 to 1000 cells per square inch, or 50 to 600, or less than or equal to 1000 cells per square inch and greater than or equal to 20 squares per square inch and less than, equal to, or greater than 40 squares per square inch, 60, 80, 100, 120, 140, 160, 180, 200, 220, 240, 260, 280, 300, 320, 340, 360, 400, 450, 500, 550, 600, 650, 700, 750, 800, 850, 900, or 950 cells per square inch. The cells in the honeycomb form have any suitable wall thickness, such as a wall thickness of 0.001 inches to 0.1 inches, or 0.002 inches to 0.05 inches, or less than or equal to 0.1 inches and greater than or equal to 0.001 inches and less than, equal to, or greater than 0.002 inches, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, 0.025, 0.03, 0.035, 0.04, or 0.045 inches. In various aspects, the cells in the honeycomb form can include a geometry of 100/8 or 200/8 cells per square inch/0.001″ wall thickness.

The monolithic substrate can have any suitable open frontal area. The open frontal area (or OFA) is the percent cross-sectional area of the longitudinal channels in the honeycomb form that is, for example, available for gas to flow therethrough. In contrast, the closed frontal area (or CFA) is the percent cross-sectional (perpendicular to the axial or longitudinal direction) area of the intersecting walls of the substrate (i.e., excluding the open frontal area). For example, the monolithic substrate can have an open frontal area of 70-95%, 75-90%, 78-85%, or less than 95% and greater than or equal to 70% and less than, equal to, or greater than 71, 72, 73, 74, 75, 76, 77, 78, 79, 80, 81, 82, 83, 84, 85, 86, 87, 88, 89, 90, 91, 92, 93, or 94%.

The monolithic substrate can optionally include a coating including a catalyst, a sorbent that adsorbs and desorbs CO₂, or some other functional material, or a combination thereof. In various aspects, the coating can be directly adhered to the material of the glass and/or ceramic matrix, wherein the monolithic substrate is free of an intervening bonding layer between the coating and the glass and/or ceramic matrix. However, in various aspects, the monolithic substrate can include a bonding layer. The bonding layer can be any suitable bonding layer. The bonding layer can be a washcoat material. The bonding layer can include a deposition of high surface area particles, such as gamma alumina, zeolite, activated carbon, or a combination thereof. A coating that includes the sorbent can be the sorbent or can include one or more other components. A coating that includes a catalyst can be the catalyst or can include one or more other components. The sorbent can be any suitable sorbent that adsorbs and desorbs CO₂, such as a zeolite, sodium carbonate, activated carbon, carbon nanotubes, a metal-organic framework (MOF), an amine, or a combination thereof. The monolithic substrate including a coating including a sorbent and/or catalyst can include any suitable loading level of the sorbent or of the catalyst, such as 0.1 wt % to 99% (e.g., wherein 0.1 wt % to 99 wt % of the monolithic substrate including the coating is the sorbent or catalyst), 1 wt % to 90 wt %, or less than or equal to 99% and greater than or equal to 0.1 wt % and less than, equal to, or greater than 1 wt %, 2, 4, 6, 8, 10, 12, 16, 18, 20, 25, 30, 35, 40, 45, 50, 55, 60, 65, 70, 75, 80, 82, 84, 86, 88, 90, 91, 92, 93, 94, 95, 96, 97, or 98 wt %.

The monolithic substrate can be an extruded, dried, and fired product of an extrudable composition. The extrudable composition, which can alternatively be referred to as a batch, batch mixture, or batch composition, can also include an inorganic particulate material (e.g., inorganic particles) for forming the matrix (e.g., array of intersecting walls) of the substrate, which in turn forms the first pores as spaces or interstices between the particulate material. Accordingly, the particulate material can be selected as particles that have relatively poor packing, such as platy (plate-like) particles that creates such spaces or interstices when the platy particles are packed together. The particulate material can be selected so that it is stable to firing at a temperature of at least 600° C. The extrudable composition can include a binder and/or sintering aid. The extrudable composition can be an extrudable paste comprising the foregoing ingredients combined with a liquid component, such as water, in addition to oils, fatty acids, or other extrusion aids or lubricants.

The particulate material for forming the first pores can be stable (e.g., does not pyrolyze or degrade) to firing (e.g., firing under any suitable gas, such as including air, inert gas, oxygen (e.g., 5 to 21% oxygen), or a combination thereof) at 600° C. (e.g., at or below 600° C.), 950° C., 1100° C., or at less than or equal to 1100° C. and greater than or equal to 600° C. and less than, greater than, or equal to 650, 700, 750, 800, 850, 900, 950, 1000, or 1050° C. In some aspects, higher temperatures (e.g., temperatures above about 1050° C. or even above about 1000° C.) are avoided, as these higher temperatures tend to result in not only the sintering of inorganic particles, but also the reaction of inorganic particles into one or more ceramic phases. As described below, the firing conditions can be selected to result primarily in the sintering of particles together, while avoiding thorough reaction of the particles into further ceramic materials, in order preserve the first pores in the monolith after firing.

The particulate material for forming the first pores can have any suitable particle diameter, such as a median particle diameter of 0.2 microns to 20 microns, or less than or equal to 20 microns and greater than or equal to 0.2 microns and less than, equal to, or greater than 0.4, 0.6, 0.8, 1, 1.5, 2, 2.5, 3, 3.5, 4, 4.5, 5, 6, 7, 8, 9, 10, 11, 12, 13, 14, 15, 16, 17, 18, or 19 microns. The particulate material can include a silicate, aluminate, oxide, glass, carbide, or combination thereof. The particulate material can include diatomaceous earth, quartz, fused silica, cordierite, clay, talc, zeolite, spinel, wollastonite, mica, basalt, feldspar, aluminum oxide, glass powder, silicon carbide, or a combination thereof.

The particulate material can form any suitable proportion of the extrudable composition, on a dry weight basis, such as 50 wt % to 90 wt % of the extrudable composition, 60 wt % to 80 wt %, or less than or equal to 90 wt % and greater than or equal to 50 wt % and less than, equal to, or greater than 52 wt %, 54, 56, 58, 60, 62, 64, 66, 68, 70, 72, 74, 76, 78, 80, 82, 84, 86, or 88 wt %. As described herein, the particulate material for forming the first pores can form pores via interstices between the particles, via pores present in the particles themselves, or a combination thereof.

Additionally, since the liquid component and organics in an extrudable composition are expected to burn out or otherwise be removed during drying and firing, and by selecting firing conditions that sinter the particles together while preserving the particles and interstices as described herein, the wt % of each inorganic particle ingredient in the batch mixture, with respect to 100% inorganics in the batch mixture, is expected to correspond approximately to the wt % of the corresponding particulate material in the resulting monolithic substrate. Accordingly, for the purposes of this disclosure, any values or ranges provided herein for the amount of inorganic particles in a batch mixture, with respect to 100% inorganics in the batch mixture, are intended in this disclosure to also refer to the approximate amount of the corresponding particulate material in the resulting monolithic substrate. For example, 50 wt % diatomaceous earth particles in the batch mixture with respect to 100% inorganics in the batch mixture is to be understood as also referring to diatomaceous earth comprises about 50 wt % of the particulate material in the resulting monolith substrate (after the liquid component and organic components are removed during drying and firing).

Accordingly, the particulate material that results in the first (fine) pores (e.g., due to inherent porosity of the particles and/or interstices formed between the particles during packing), such as any combination of one or more of diatomaceous earth, hollow glass microspheres, and platy talc, can form any suitable proportion of the monolithic substrate, such as at least 50 wt %, at least 60 wt %, at least 70 wt %, at least 75 wt %, at least 80 wt %, at least 90 wt %, or even up to 95 wt %, including ranges having these values as end points, such as from 50 wt % to 60 wt %, from 50 wt % to 70 wt %, from 50 wt % to 75 wt %, from 50 wt % to 80 wt %, from 50 wt % to 90 wt %, from 50 wt % to 95 wt %, from 60 wt % to 70 wt %, from 60 wt % to 75 wt %, from 60 wt % to 80 wt %, from 60 wt % to 90 wt %, from 60 wt % to 95 wt %, from 70 wt % to 80 wt %, from 70 wt % to 90 wt %, from 70 wt % to 95 wt %, from 75 wt % to 90 wt %, from 75 wt % to 95 wt %, from 80 wt % to 90 wt %, from 80 wt % to 95 wt %, or even from 85 wt % to 95 wt %.

The particulate material of the monolithic substrate can comprise diatomaceous earth particles in an amount of at least 30 wt %, at least 35 wt % at least 40 wt %, at least 45 wt %, at least 50 wt %, at least 60 wt %, at least 70 wt %, at least 75 wt % such as up to 80 wt %, or even 85 wt % of the monolithic substrate, including ranges having these values as endpoints, such as from 30 wt % to 50 wt %, from 30 wt % to 60 wt %, from 30 wt % to 70 wt %, from 30 wt % to 75 wt %, from 30 wt % to 80 wt %, from 30 wt % to 85 wt %, from 40 wt % to 50 wt %, from 40 wt % to 60 wt %, from 40 wt % to 70 wt %, from 40 wt % to 75 wt %, from 40 wt % to 80 wt %, from 40 wt % to 85 wt %, from 50 wt % to 60 wt %, from 50 wt % to 70 wt %, from 50 wt % to 75 wt %, from 50 wt % to 80 wt %, from 50 wt % to 85 wt %, from 60 wt % to 75 wt %, from 60 wt % to 80 wt %, from 75 wt % to 85 wt %, or even from 80 wt % to 85 wt % of the monolithic substrate.

The particulate material of the monolithic substrate can comprise platy talc particles in an amount of at least 15 wt %, at least 20 wt %, or at least 30 wt % when used in combination with other particles to form the first pores (e.g., when used together with diatomaceous earth), and when used as a primary component for forming the first pores plat talc can comprise at least 50 wt %, at least 60 wt %, at least 70 wt %, at least 80 wt %, at least 90 wt %, or even up to 95 wt % of the monolithic substrate, including ranges having these values as endpoints, such as from 50 wt % to 60 wt %, from 50 wt % to 70 wt %, from 50 wt % to 80 wt %, from 50 wt % to 90 wt %, from 50 wt % to 95 wt %, from 60 wt % to 70 wt %, from 60 wt % to 80 wt %, from 60 wt % to 90 wt %, from 60 wt % to 95 wt %, from 70 wt % to 80 wt %, from 70 wt % to 90 wt %, from 70 wt % to 95 wt %, from 80 wt % to 90 wt %, from 80 wt % to 95 wt %, or even from 90 wt % to 95 wt % of the monolithic substrate.

The particulate material of the monolithic substrate can comprise hollow glass microsphere particles in an amount of at least at least 20 wt %, at least 25 wt %, at least 30 wt %, or at least 35 wt % of the monolithic substrate when used in combination with other particles to form the first pores (e.g., when used together with diatomaceous earth and/or talc), such as up to 50 wt % of the monolithic substrate, including ranges having these values as endpoints, such as from such as from 20 wt % to 30 wt %, from 20 wt % to 35 wt %, from 20 wt % to 40 wt %, from 20 wt % to 45 wt %, from 20 wt % to 50 wt %, from 30 wt % to 40 wt %, from 30 wt % to 45 wt %, from 30 wt % to 50 wt %, from 35 wt % to 40 wt %, from 35 wt % to 45 wt %, from 35 wt % to 50 wt %, from 40 wt % to 45 wt %, from 40 wt % to 50 wt % of the monolithic substrate.

The binder and/or sintering aid can include any suitable binder and/or sintering aid, such as an inorganic binder, a polymer, a thermosetting resin, a carbon precursor, a borate, a phosphate, a transition metal oxide, an oxide, a hydroxide, a carbonate, a silicate (e.g., alkali earth silica and/or alkaline earth silicate), an alumino-silicate, Fe₂O₃, boric acid, K₂CO₃, a cellulose derivative, or a combination thereof. The cellulose derivative can include (C₁-C₃)alkylhydroxy (C₁-C₃)alkyl cellulose, or a (C₁-C₃)alkylhydroxy cellulose, or a (C₁-C₃)alkylcellulose, or a (C₁-C₃)alkyl (C₁-C₃)alkylcellulose or methylhydroxypropyl cellulose, methylhydroxyethyl cellulose, methylhydroxymethyl cellulose, methylcellulose, ethylcellulose, propylcellulose, hydroxypropylcellulose, methylethyl cellulose, sodium carboxymethylcellulose, or a combination thereof. In various aspects, the binder and/or sintering aid can include a material that includes a crystalline or glassy structure. The binder and/or sintering aid can form any suitable proportion of the extrudable composition, on a dry weight basis, such as 1 wt % to 30 wt % of the extrudable composition, 2 wt % to 26 wt % of the extrudable composition, or less than or equal to 30 wt % and greater than or equal to 1 wt % and less than, equal to, or greater than 2 wt %, 3, 4, 5, 6, 7, 8, 9, 10, 11, 12, 13, 14, 15, 16, 17, 18, 19, 20, 21, 22, 23, 24, 25, 26, 27, 28, or 29 wt %. With respect to total inorganics (as opposed to total dry weight), the pore former can be provided in the extrudable composition in an amount of 10 wt % to 50% as a superaddition with respect to 100% inorganic particles in the extrudable composition, such as from 20 wt % to 40 wt % superaddition.

The extrudable composition can further include a pore-forming material for forming the second pores. The pore-forming material can include any suitable material that degrades and/or pyrolyzes (e.g., burns out) during the firing to leave behind pores in the material that approximately corresponding to the particle size of the pore-forming material. The pore-forming material can be any suitable pore-forming material, such as a starch (e.g., a cross-linked starch), a nut-shell flour, carbon, a natural polymer, a synthetic polymer, a carbonaceous material, crystalline carbon, amorphous carbon, or a combination thereof. The pore forming material can form any suitable proportion of the extrudable composition, on a dry weight basis, such as 5 wt % to 45 wt % of the extrudable composition, 10 wt % to 35 wt % of the extrudable composition, or less than or equal to 45 wt % and greater than or equal to 5 wt % and less than, equal to, or greater than 6, 8, 10, 12, 14, 16, 18, 20, 22, 24, 26, 28, 30, 32, 34, 36, 38, 40, 42, or 44 wt %. With respect to total inorganics (as opposed to total dry weight), the pore former can be provided in the extrudable composition in an amount of 10 wt % to 50% as a superaddition with respect to 100% inorganic particles in the extrudable composition, such as from 20 wt % to 40 wt % superaddition. In various aspects, the extrudable composition can be substantially free of the pore-forming material; for example, the pore-forming material can be 0 wt % of the extrudable composition, or 0 wt % to 5 wt %, or less than or equal to 5 wt %, 4, 3, 2.5, 2, 1.5, 1, 0.5, 0.1, or less than or equal to 0.01 wt %.

The extrudable composition can further include one or more liquid components, or solvents, such as an aqueous or organic liquid component or solvent. The liquid component can be or include water. The liquid component can form any suitable proportion of the extrudable composition, such as 5 wt % to 50 wt %, or 10 wt % to 40 wt %, or less than or equal to 50 wt % and greater than or equal to 5 wt % and less than, equal to, or greater than 6, 8, 10, 12, 14, 16, 18, 20, 22, 24, 26, 28, 30, 32, 34, 36, 38, 40, 42, 44, 46, or 48 wt % as a super addition with respect to 100% of a total weight of dry solids in the extrudable mixture.

### Method of Forming a Monolithic Substrate.

In various aspects, the present disclosure provides a method of forming the monolithic substrate. The method can include extruding the extrudable composition. The method can include drying the extruded composition. The method can also include firing the dried extruded composition, to form the monolithic substrate. The method can optionally include applying a coating to the monolithic substrate, wherein the coating includes a catalyst, a sorbent that can absorb and desorb CO₂, or a combination thereof.

The drying can be any suitable drying that substantially removes solvent from the extruded composition. The drying can include heating, air flow, and/or exposing to microwave or other energy source. The drying can include placing the extruded composition under a vacuum. The drying can include drying at a sufficient temperature and for a sufficient duration to substantially remove all solvent from the extruded composition (e.g., such that the dried composition has a solvent content less than 5 wt %, or less than 2 wt %, less than 1 wt %, less than 0.5 wt %, or less than 0.1 wt %).

The firing can be any suitable firing (e.g., heating for a suitable duration, at a suitable temperature, and under a suitable atmosphere) that sinters one or more of the components of the extruded composition (e.g., that sinters the binder and/or sintering aid) and that degrades and/or pyrolyzes any pore-forming materials for forming the second pores that are present in the extrudable composition, to form the ceramic and/or glass matrix including the continuous interconnected pore structure described herein. The firing can be conducted under any suitable atmosphere, such as any suitable gas, such as including air, inert gas (e.g., nitrogen), oxygen (e.g., 5 to 21% oxygen), or a combination thereof. The firing can include firing at a firing temperature sufficient to cause reaction and/or sintering of the binder, sintering aid, and/or the particulate material for forming the first pores, such as a firing temperature of 600° C. to 1100° C., or 750° C. to 950° C., or at less than or equal to 1100° C. and greater than or equal to 600° C. and less than, equal to, or greater than 650, 700, 750, 800, 850, 900, 950, 1000, or 1050° C. The firing can include firing for a duration of (e.g., maintaining the firing temperature for a duration of) 1 h to 24 h, or 2 h to 6 h, or less than or equal to 24 h and greater than or equal to 1 h and less than, equal to, or greater than 2 h, 3, 4, 5, 6, 8, 10, 12, 14, 16, 18, 20, or 22 h.

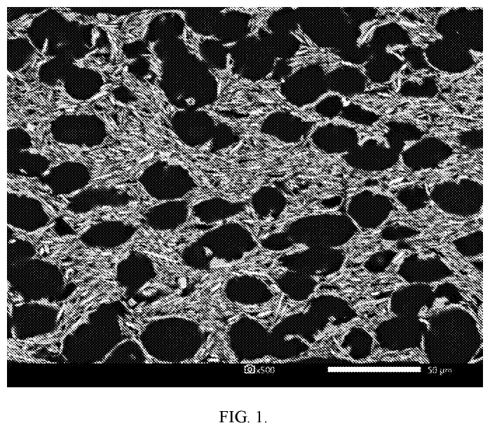

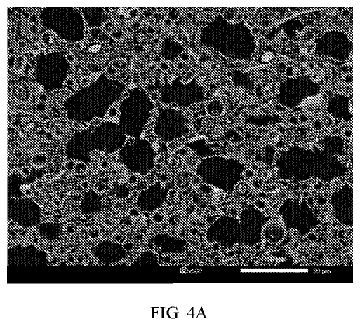

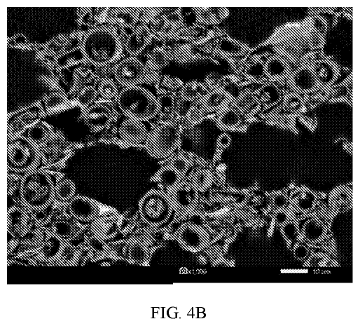

The firing temperature and type of particulate material can be selected such that the particles of the particulate material are sintered together as a result of the firing process, but without significant reaction of the particles into one or more ceramic phases. That is, the particulate material and firing conditions are selected according to the present disclosure so that the particles are sintered together, but any reaction into ceramic phases is restricted primarily to the interfaces between particles where the sintering occurs. For example, as shown in the examples of FIG. 1 and FIG. 4A, the individual particles of the particulate material (talc particles in the case of FIG. 1 and diatomaceous earth particles in the case of FIG. 4A) largely retain their original shape and size even after being fired into a monolith. As a result, the monoliths disclosed herein (and as exhibited by the examples of FIGS. 1 and 4A) can each be described as an agglomerate of sintered particles. In comparison, raw material ceramic precursor particles used in traditional ceramics manufacturing may be fired for a duration and at a temperature sufficient to more fully react the precursor particles and convert a green ceramic body into a homogeneous construct of one or more ceramic phases. However, the reaction of ceramic precursors into ceramic phases correspondingly causes the interstitial spaces between the original precursor particles to be destroyed. Thus, by preserving the nature of the particles in the particulate material after sintering (creating the monoliths as agglomerates of sintered particles), the spaces or interstices between the particles is correspondingly also preserved, which results in presence of the first pores in the monoliths disclosed herein.

In various aspects, the monolithic substrates can include particles that are sintered together but that are still visible as discrete particles under SEM. For example, the particulate material for forming the first pores can sinter together during the firing but can retain portions of their particulate-shapes within the ceramic and/or glass matrix. In various aspects, retention of the particulate-shapes of the particulate material during firing can provide formation of the first pores.

### Method of Using Monolithic Substrate.

Various aspects of the present disclosure provide a method of using the monolithic substrate that includes a coating thereon that includes a sorbent that can adsorbs and desorbs CO₂. The method can include exposing the monolithic substrate to a gas stream that includes CO₂ to at least partially adsorb the CO₂ from the gas stream. The method can also include desorbing the CO₂ from the coating on the monolithic substrate. In various aspects, desorbing the CO₂ from the coating on the monolithic substrate includes heating the monolithic substrate, such as via resistive heating, sending hot gas (e.g., steam) through the monolithic substrate, microwave heating, induction heating, via an external heat source at a periphery of the monolithic substrate, or a combination thereof. In various aspects, desorbing the CO₂ from the coating can include sequestering the CO₂, such as placing the CO₂ in a storage tank.

The methods of using the monolithic substrate described herein can be used for any suitable method of CO₂-removal, such as direct air capture (DAC) or capture of CO₂ at an effluent source. The monolithic substrate described herein can be capable of withstanding temperatures of 200° C. or more and withstanding moist environments.

Various aspects of the present disclosure provide a method of using the monolithic substrate that includes a coating thereon that includes a catalyst. The method can include exposing the monolithic substrate to a gas stream to catalyze a chemical reaction of one or more components of the gas stream using the catalyst.

### EXAMPLES

Various aspects of the present disclosure can be better understood by reference to the following Examples which are offered by way of illustration. The present disclosure is not limited to the Examples given herein. Firing was conducted under 5-21% oxygen in air or in a mixture of air and nitrogen. Mercury porosimetry was performed as per ASTM D6761-07 (2012). The monoliths may be referred to in the description of the Examples interchangeably as monoliths, parts, pieces, bodies, samples, or articles.

Compositions, firing conditions, and physical properties of the resulting substrate are shown in Tables 1-2. Tables 3 and 4 show the same examples as Tables 1 and 2, respectively, but with the dry inorganic and organic components provided in wt % with respect to 100% dry solids in the mixture (as opposed to with respect to 100% inorganics as in Tables 1-2). Since Examples in Tables 3 and 4 are the same as those in Tables 1 and 2, the firing conditions and properties are not repeated in Tables 3 and 4.

Accordingly, in Tables 1-2, inorganics are provided in wt % and organic materials provided in wt % as superaddition with respect to 100% inorganics. The inorganic materials and organic materials together yield a total for dry solids in the mixture. In Tables 3-4, the dry inorganics and organics are provided with respect to 100% dry solids. The water and oil (MOx) are also given in wt %, but in terms of superaddition to 100 parts total dry solids (the sum of inorganics and organics together). Since the liquid component and organics are expected to burn out during firing, the wt % of each inorganic particle component in the batch mixture is expected to correspond approximately to the wt % of each particulate material in the resulting monolithic substrate. Accordingly, any values or ranges for the amount of inorganic particles in the batch mixtures are intended in this disclosure to refer to the amount of that material as the particulate material in the resulting monolithic substrate. For example, 50 wt % diatomaceous earth particles in the batch mixture with respect to 100% inorganics in the batch mixture is to be understood as also referring to 50 wt % of diatomaceous earth of the particulate material in the resulting monolith substrate (after the liquid component and organic components are removed during drying and firing).

The first set of rows show the inorganic raw materials used and the amount used (wt %). Diafil 525 and Celtix are types of diatomaceous earth. Tecosil 44C is fused silica. C70 HGMS is hollow glass microspheres having an average particle size of 15 microns. Kaolin clay and platy talc particles were also used in some examples. While the packing of all of the particle materials contributed at least partially to the formation of the fine pores due to incomplete packing of the particles, in particular the diatomaceous earth, hollow glass microspheres, and talc particles contributed most significantly to formation of the first (fine) pores as described herein. As a result, the monoliths created in accordance with the Examples were agglomerates of sintered particles consistent with the disclosure herein, where the particulate matter was primarily (at least 50 wt % of dry ingredients) a combination of one or more of diatomaceous earth, hollow glass microspheres, or talc. However, as described herein, any other combination of particles having inherent porosity and/or packing behavior that results in the formation of interstices between particles, could be used. The clay and fused silica also functioned as a filler, and the mica particles as a sintering aid to assist in ensuring the inorganics yielded a suitably strong monolith after sintering. Two different types of mica were added for filler and sintering aid purposes in the form of Suzorite 325 Phlogopite and C4000 Muscovite. Potassium carbonate (K₂CO₃) and boric acid were also used as sintering aids as summarized in the Tables.

The organic materials and water used are shown next and the amounts used are given in terms of superadditions to 100 parts inorganics. The pea starch is cross-linked pea starch. MOx refers to an antioxidant-stabilized lubricating mineral oil.

Unless stated otherwise, the inorganics (e.g., particulate material and sintering aids) in the present Examples were first dry mixed in a Littleford mixer, followed by addition of water and organics with an additional wet mix cycle. The wet powder was then transferred into a 40 mm twin screw mixer and extruded through 2″ diameter dies of either 100 cells per square in (cpsi)/8 mil slots, 200 cpsi/8 mil slots, or 400 cpsi/4 mil slots, as indicated in the Tables. The parts were dried in a microwave dryer and fired in a gas kiln to temperatures in the range of 750° C. to 950° C. for 4 hours, as also indicated in the Tables.

Tables 1-2 next show the firing soak temperature. Each part sample was heated at a rate of 50° C./hr to the soak temperature where it was held for 4 hours. The geometry is given as a nominal cell density (cells/in² or cpsi) and web thickness in mils. For example, a 100/8 geometry refers to a part with a nominal cell density of approximately 100 cpsi and a wall thickness of 8 mils. CFA is the closed frontal area of the honeycomb body in percent determined as the two-dimensional cross-sectional area (perpendicular to the axial length) of the matrix portion of the substrate (thus excluding the open channels). Bulk density of the porous material is given in the next row (independent of the channels of the honeycomb structure) as measured by mercury porosimetry. Porosity is a vol % determined by mercury porosimetry. The median pore diameter (of the entire pore size distribution) is given next in microns as determined by mercury porosimetry. In the next two rows, the pore size corresponding to the coarse and fine peaks of the bimodal distributions are given (again, referring to the pore sizes at which the maximum value of the coarse and fine peaks of the differential intrusion plot is located). The next row gives the total mercury intrusion volume and the following row gives the mercury intrusion volume at the inflection point in the curve of cumulative intrusion volume as a function of pressure (or pore size). The next row gives a calculation of the percentage of coarse pore volume by dividing the intrusion volume up to the inflection point by the total intrusion volume and multiplying by 100. The next row shows the percentage of fine pore volume which can be calculated by subtracting the coarse pore volume % from 100 (or by dividing the fine pore intrusion volume (intrusion volume at the inflection point subtracted from the total intrusion volume) by the total intrusion volume and multiplying by 100). Modulus of rupture (MOR) is measured by a 4-point bend test of a rectangular bar cut out of the fired parts, as per ASTM D6272. In the last row, MOR is normalized by the CFA to eliminate influence of cell geometry. In some cases, multiple monoliths were manufactured from the same batch mixture but under different conditions, which is denoted by use of the same Example number appended with a different alphabetic suffix (e.g., Ex. 1A and Ex. 1B were each made from the same batch mixture but under different firing temperatures).

TABLE 1
Example compositions, firing conditions, and physical properties of resulting multimodal substrates.

| Example | Ex. 1A | Ex. 1B | Ex. 2 | Ex. 3 | Ex. 4 | Ex. 5 | Ex. 6 | Ex. 7 | Ex. 8A | Ex. 8B |
|---|---|---|---|---|---|---|---|---|---|---|
| Inorganics | wt % | | | | | | | | | |
| Diafil 525 | | | | 50 | 60 | 50 | 50 | 50 | 50 | 50 |
| Celtix | | | 80 | | | | | | | |
| Platy Talc | 93.4 | 93.4 | | 30 | 20 | 30 | 30 | 20 | | |
| Kaolin Clay | | | 13.3 | 15.5 | 15.5 | 15.5 | 15.5 | 25.5 | 25 | 25 |
| Suzorite 325 Phlogopite | | | | | | | | | 25 | 25 |
| Boric Acid | 5.9 | 5.9 | | 4 | 4 | 4 | 4 | 4 | | |
| K2CO3 | 0.7 | 0.7 | 5.9 | 0.5 | 0.5 | 0.5 | 0.5 | 0.5 | | |
| Organics | wt % superaddition to 100% inorganics | | | | | | | | | |
| Pea Starch (crosslinked) | 40 | 40 | 20 | 40 | 30 | 20 | 30 | 40 | 40 | 40 |
| Methycellulose | 6 | 6 | 5 | 5 | 5 | 5 | 5 | 5 | 5 | 5 |
| Sodium Stearate | 1.2 | 1.2 | 6 | | | | | | | |
| Sum, dry solids, as | 147.2 | 147.2 | 130.2 | 145 | 135 | 125 | 135 | 145 | 145 | 145 |
| superaddition | | | | | | | | | | |
| Liquids | wt % superaddition to 100% dry solids | | | | | | | | | |
| MOx | 10 | 10 | 10 | 10 | 10 | 10 | 10 | 10 | 10 | 10 |
| Water | 49 | 49 | 67 | 64 | 64 | 57 | 60 | 62 | 65 | 65 |
| Conditions and Properties | | | | | | | | | | |
| Firing Temperature (° C.) | 950 | 850 | 850 | 950 | 950 | 950 | 950 | 950 | 850 | 950 |
| Geometry | 100/8 | 100/8 | 100/8 | 200/8 | 200/8 | 200/8 | 200/8 | 200/8 | 200/8 | 200/8 |
| CFA (%) | 15.4 | 16.4 | 15.4 | 22.6 | 22.6 | 22.6 | 22.6 | 22.6 | 22.6 | 22.6 |
| Bulk Density (g/cm3) | 0.82 | 0.81 | 0.66 | 0.73 | 0.72 | 0.86 | 0.79 | 0.72 | 0.69 | 0.73 |
| Porosity (%) | 70.2 | 69.6 | 65.4 | 68.4 | 66.9 | 61.1 | 64.1 | 69.9 | 68.1 | 66.5 |
| MPD (μm) | 4.4 | 4.4 | 4.4 | 3.5 | 0.72 | 0.58 | 0.89 | 0.72 | 0.9 | 1.22 |
| Peak of coarse porosity (μm) | 6.0 | 6 | 8.16 | 5.3 | 6.06 | 6.06 | 2.6 | 3.35 | 2.94 | 6.09 |
| Peak of fine porosity (μm) | 0.6 | 0.4 | 0.817 | 0.73 | 0.4 | 0.4 | 0.85 | 5.07 | 0.24 | 0.37 |
| Total intrusion volume (ml/g) | 0.856 | 0.860 | 0.986 | 0.939 | 0.928 | 0.717 | 0.816 | 0.970 | 0.982 | 0.908 |
| Pore volume at inflection | 0.557 | 0.555 | 0.300 | 0.568 | 0.549 | 0.044 | 0.382 | 0.607 | 0.500 | 0.470 |
| (ml/g) | | | | | | | | | | |
| Coarse pore volume (%) | 65.1 | 64.5 | 30.4 | 60.5 | 59.2 | 6.2 | 46.8 | 62.6 | 50.9 | 51.8 |
| Fine pore volume (%) | 34.9 | 35.5 | 69.6 | 39.5 | 40.8 | 93.8 | 53.2 | 37.4 | 49.1 | 48.2 |
| MOR (psi) | 297 | 129 | 219 | 348 | 369 | 465 | 465 | 376 | 189 | 395 |
| MOR normalized (psi) | 1929 | 787 | 1422 | 1540 | 1633 | 2058 | 2058 | 1664 | 836 | 1748 |

TABLE 2
Example compositions, firing conditions, and physical properties of resulting multimodal substrates,
with organic materials and water given in terms of superadditions to 100 parts inorganics.

| Example | Ex. 9 | Ex. 10 | Ex. 11 | Ex. 12 | Ex. 13 | Ex. 14 | Ex. 15 | Ex. 16 | Ex. 17 |
|---|---|---|---|---|---|---|---|---|---|
| Inorganics | wt % | | | | | | | | |
| Diafil 525 | 50 | 50 | 50 | | 80 | 40 | 40 | 35 | |
| Celtix | | | | 50 | | 40 | | | |
| Tecosil 44C | 30 | 30 | | | | | | | |
| C70 HGMS | | | | | | | 40 | 35 | |
| Platy Talc | | | | | | | | 15 | 60.3 |
| Kaolin Clay | 15.5 | 15.5 | 25 | 25 | 15.5 | 15.5 | 15.5 | 15 | 14.3 |
| Suzorite 325 Phlogopite | | | | 25 | | | | | |
| C4000 Muscovite | | | 25 | | | | | | |
| Fe2O3 | | | | | | | | | 19.0 |
| Boric Acid | 4 | 4 | | | 4 | 4 | 4 | | 5.6 |
| K2CO3 | 0.5 | 0.5 | | | 0.5 | 0.5 | 0.5 | | 0.7 |
| Organics | wt % superaddition to 100% inorganics | | | | | | | | |
| Pea Starch (crosslinked) | 40 | 20 | 40 | 40 | 20 | 20 | 30 | 0 | 40.0 |
| Methylcellulose | 5 | 5 | 5 | 5 | 5 | 5 | 7.5 | 5 | 3.5 |
| sum (dry solids) | 145 | 125 | 145 | 145 | 125 | 125 | 137.5 | 105 | 143.5 |
| Liquids | wt % superaddition to 100% dry solids | | | | | | | | |
| MOx | 10 | 10 | 10 | 10 | 10 | 10 | 10 | 10 | 10 |
| Water | 55 | 55 | 62 | 79 | 65 | 83 | 55 | 40 | 42 |
| Conditions and Properties | | | | | | | | | |
| Firing Temperature (° C.) | 950 | 950 | 950 | 950 | 750 | 950 | 750 | 850 | 850 |
| Geometry | 200/8 | 400/4 | 200/8 | 200/8 | 200/8 | 200/8 | 200/8 | 200/8 | 200/8 |
| CFA (%) | 22.6 | 17.2 | 22.6 | 22.6 | 22.6 | 22.6 | 22.6 | 22.6 | 22.6 |
| Bulk Density (g/cm3) | 0.73 | 0.85 | 0.72 | 0.62 | 0.69 | 0.64 | 0.66 | 0.85 | 0.87 |
| Porosity (%) | 66.2 | 59.54 | 66.9 | 71.3 | 63.3 | 66.1 | 65.5 | 61.2 | 69.9 |
| MPD (μm) | 4.81 | 1.12 | 1.32 | 1.15 | 0.69 | 0.28 | 2.19 | 1.1 | 3.35 |
| Peak of coarse porosity (μm) | 6.14 | 6.8 | 2.5 | 1.62 | 3.88 | 5.3/1.3 | 6.6 | 1.6 | 4.36 |
| Peak of fine porosity (μm) | 0.4 | 0.59 | 0.23 | 0.26 | 0.28 | 0.43 | 0.35 | 0.29 | 0.19 |
| Total intrusion volume (ml/g) | 0.907 | 0.704 | 0.925 | 1.152 | 0.923 | 0.771 | 0.804 | 0.687 | 0.802 |
| Pore volume at inflection | 0.597 | 0.318 | 0.527 | 0.583 | 0.419 | 0.314 | 0.558 | 0.553 | 0.675 |
| (ml/g) | | | | | | | | | |
| Coarse pore volume (%) | 65.8 | 45.2 | 57.0 | 50.6 | 45.4 | 40.7 | 69.4 | 80.5 | 84.2 |
| Fine pore volume (%) | 34.2 | 54.8 | 43.0 | 49.4 | 54.6 | 59.3 | 30.6 | 19.5 | 15.8 |
| MOR (psi) | 266 | 224 | 282 | 192 | 193 | 266 | 307 | 582 | 293 |
| MOR normalized (psi) | 1177 | 1302 | 1248 | 850 | 854 | 1177 | 1358 | 2575 | 1296 |

TABLE 3
Example compositions corresponding to the Examples of Table
1 but reported in wt % with respect to 100% dry solids.

| Example | Ex. 1A | Ex. 1B | Ex. 2 | Ex. 3 | Ex. 4 | Ex. 5 | Ex. 6 | Ex. 7 | Ex. 8A/B |
|---|---|---|---|---|---|---|---|---|---|
| Inorganics | wt % | | | | | | | | |
| Diafil 525 | 0.00 | 0.00 | 0.00 | 34.48 | 44.44 | 40.00 | 37.04 | 34.48 | 34.48 |
| Celtix | 0.00 | 0.00 | 63.54 | 0.00 | 0.00 | 0.00 | 0.00 | 0.00 | 0.00 |
| Platy Talc | 63.45 | 63.45 | 0.00 | 20.69 | 14.81 | 24.00 | 22.22 | 13.79 | 0.00 |
| Kaolin Clay | 0.00 | 0.00 | 10.56 | 10.69 | 11.48 | 12.40 | 11.48 | 17.59 | 17.24 |
| Suzorite 325 Phlogopite | 0.00 | 0.00 | 0.00 | 0.00 | 0.00 | 0.00 | 0.00 | 0.00 | 17.24 |
| Boric Acid | 4.01 | 4.01 | 0.00 | 2.76 | 2.96 | 3.20 | 2.96 | 2.76 | 0.00 |
| K2CO3 | 0.48 | 0.48 | 4.69 | 0.34 | 0.37 | 0.40 | 0.37 | 0.34 | 0.00 |
| Organics | wt % | | | | | | | | |
| Pea Starch (crosslinked) | 27.17 | 27.17 | 0.00 | 27.59 | 22.22 | 16.00 | 22.22 | 27.59 | 27.59 |
| Methycellulose | 4.08 | 4.08 | 15.89 | 3.45 | 3.70 | 4.00 | 3.70 | 3.45 | 3.45 |
| Sodium Stearate | 0.82 | 0.82 | 4.77 | 0.00 | 0.00 | 0.00 | 0.00 | 0.00 | 0.00 |
| Sum, dry solids | 100 | 100 | 100 | 100 | 100 | 100 | 100 | 100 | 100 |
| Liquids | wt % superaddition to 100% dry solids | | | | | | | | |
| MOx | 10 | 10 | 10 | 10 | 10 | 10 | 10 | 10 | 10 |
| Water | 49 | 49 | 67 | 64 | 64 | 57 | 60 | 62 | 65 |

TABLE 4
Example compositions corresponding to the Examples of Table
2 but reported in wt % with respect to 100% dry solids.

| Example | Ex. 9 | Ex. 10 | Ex. 11 | Ex. 12 | Ex. 13 | Ex. 14 | Ex. 15 | Ex. 16 | Ex. 17 |
|---|---|---|---|---|---|---|---|---|---|
| Inorganics | wt % | | | | | | | | |
| Diafil 525 | 34.48 | 40.00 | 34.48 | 0.00 | 64.00 | 32.00 | 29.09 | 33.33 | 0.00 |
| Celtix | 0.00 | 0.00 | 0.00 | 34.48 | 0.00 | 32.00 | 0.00 | 0.00 | 0.00 |
| Tecosil 44C | 20.69 | 24.00 | 0.00 | 0.00 | 0.00 | 0.00 | 0.00 | 0.00 | 0.00 |
| C70 HGMS | 0.00 | 0.00 | 0.00 | 0.00 | 0.00 | 0.00 | 29.09 | 33.33 | 0.00 |
| Platy Talc | 0.00 | 0.00 | 0.00 | 0.00 | 0.00 | 0.00 | 0.00 | 14.29 | 42.04 |
| Kaolin Clay | 10.69 | 12.40 | 17.24 | 17.24 | 12.40 | 12.40 | 11.27 | 14.29 | 9.96 |
| Suzorite 325 Phlogopite | 0.00 | 0.00 | 0.00 | 17.24 | 0.00 | 0.00 | 0.00 | 0.00 | 0.00 |
| C4000 Muscovite | 0.00 | 0.00 | 17.24 | 0.00 | 0.00 | 0.00 | 0.00 | 0.00 | 0.00 |
| Fe2O3 | 0.00 | 0.00 | 0.00 | 0.00 | 0.00 | 0.00 | 0.00 | 0.00 | 13.27 |
| Boric Acid | 2.76 | 3.20 | 0.00 | 0.00 | 3.20 | 3.20 | 2.91 | 0.00 | 3.94 |
| K2CO3 | 0.34 | 0.40 | 0.00 | 0.00 | 0.40 | 0.40 | 0.36 | 0.00 | 0.48 |
| Organics | | | | | wt % | | | | |
| Pea Starch (crosslinked) | 27.59 | 16.00 | 27.59 | 27.59 | 16.00 | 16.00 | 21.82 | 0.00 | 27.87 |
| Methylcellulose | 3.45 | 4.00 | 3.45 | 3.45 | 4.00 | 4.00 | 5.45 | 4.76 | 2.44 |
| sum (dry solids) | 100 | 100 | 100 | 100 | 100 | 100 | 100 | 100 | 100 |
| Liquids | wt % superaddition to 100% dry solids | | | | | | | | |
| MOx | 10 | 10 | 10 | 10 | 10 | 10 | 10 | 10 | 10 |
| Water | 55 | 55 | 62 | 79 | 65 | 83 | 55 | 40 | 42 |

A first composition (batch mixture) in accordance with Ex. 1A and 1B was formed that was 93 wt % fine platy talc particles and 6.6 wt % sintering aid (5.9 wt % boric acid and 0.7 wt % K₂CO₃), with respect to 100% inorganics in the batch. To the composition was added 40 wt % superaddition of cross-linked pea starch, water, and the indicated organics. Each of the compositions was extruded into a honeycomb green body and the green bodies were fired at 950° C. (Ex. 1A) and 850° C. (Ex. 1B) for 4 hours. FIG. 1 illustrates a SEM micrograph of a polished section of the resulting ceramic matrix, showing coarse pores (large dark areas) and fine pore structure (small dark areas) between the sintered particles (shown in gray/white). The coarse porosity is produced by the burnout of the starch particles during firing. These pores (which result in the coarse or second pores) are about 10-30 μm in diameter. The pores (first or fine pores) formed by inefficient packing of the talc particles are much smaller, by about an order of magnitude.

The ceramic matrix was subjected to a mercury porosimetry test and the results are shown in FIGS. 2A-B. FIG. 2A illustrates cumulative intrusion (as a function of pressure converted to equivalent spherical pore diameter) versus pore size diameter of the ceramic substrate (with the arrow indicating the inflection point in the curve that can be used to distinguish the two portions of the distribution), and FIG. 2B illustrates differential intrusion versus pore size diameter of the ceramic substrate. Two distinct regions of pore sizes are shown in the differential intrusion plot of FIG. 2B, with a first peak, corresponding to the “first” or “fine” pores as referred to herein, having a first maximum value (e.g., mathematically identifiable by a first local maximum in the differential intrusion plot) that is located at about 0.4 μm and a second peak, corresponding to the “second” or “coarse” pores as referred to herein, having a second maximum value (e.g., again mathematically identifiable by a second local maximum in the differential intrusion plot) located at about 8 μm. In accordance with the preceding and consistent with the disclosure herein, reference to the location of a peak herein refers to the location of the maximum value of the peak, which can each be determined mathematically as a local maxima in the differential intrusion plot.

The peak corresponding to the coarse pores was formed from the burnout of the starch pore former is located at about 8 μm in the mercury porosimetry data. The peak located at about 0.4 μm corresponds to the pore sizes found in the spaces or interstices between the talc (or other) particles in the ceramic matrix portion (walls) of the substrate. A method to determine the relative volume in the coarse and fine portions of the distribution is to use the inflection point in the cumulative intrusion curve (indicated by the arrow in FIG. 2A). The mercury intrusion volume up to the inflection point can be counted toward the coarse part of the distribution and the intrusion volume measured after the inflection point can be counted toward the fine portion of the distribution. In the example shown here, the total intrusion volume is 0.86 mL/g. The inflection point occurs at about 0.55 mL/g. Therefore, in this Example, the intrusion volume accounting for the coarse pores is 0.55 mL/g and that for the fine pores is the difference between the total intrusion volume (0.86 mL/g) and the coarse portion (0.55 mL/g) or 0.31 mL/g. Dividing the coarse intrusion volume by the total intrusion volume, the coarse pore size can be determined to account for 64% of the total. Doing the same for the fine pore size shows that the fine pore size accounts for 36% of the total.

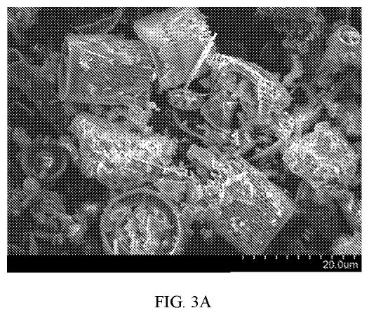

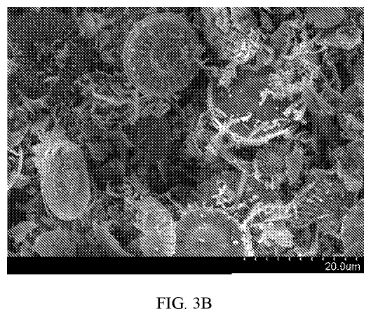

The interstices between the particles can contribute to the fine pore size once the part is fired, as shown in the microstructure shown in FIG. 1, in which talc particles were used as the main inorganic component of the composition. Another option to produce the fine pore structure is the use of materials having an internal porosity within the particles of less than 1 μm. An example of such a material is diatomaceous earth, which was used in Examples 2-16. FIGS. 3A-B illustrate SEM micrographs of diatomaceous earth particles exhibiting a fine internal pore structure (FIG. 3A: Diafil 525, FIG. 3B: Celtix). In FIGS. 3A-B, particles of having a diameter of about 10 μm can be seen having a fine pore structure within the individual particles. The fine pore structure in the particles can provide pore sizes less than 1 μm in the fired substrate.

The batch composition of Example 2 was formed comprising 80 wt % Diafil type diatomaceous earth particles (particles shown in FIG. 3A), 13 wt % clay, and 6.6 wt % sintering aid (5.9 wt % boric acid and 0.7 wt % K₂CO₃), with respect to 100% inorganics in the mixture, followed by superaddition of 20 wt % cross-linked pea starch, as well as water and the indicated inorganics. The composition was fired at 850° C. for 4 hours. FIG. 4A-B illustrate SEM micrographs of a polished cross section of monolith formed in accordance with Example 2 at two different magnifications. Large black areas are the coarse pores, while the fine porosity results from the combination of interstitial pores (pores between the particles) plus the pore sizes within (inherent to) the diatomaceous earth particles themselves. FIGS. 4A-B illustrates that the fine porosity from the diatomaceous earth particles survives the extrusion and firing processes under the stated conditions.

The pore sizes of the coarse and fine portions of the pore distributions can be manipulated to some extent by manipulating the raw materials in the batch composition. For example, the addition of more coarse pore former results in a higher volume of coarse porosity, such as shown in Examples 3-5 where the same inorganic particles are utilized at different amounts of pore former superaddition. Likewise, the amounts of the raw material with inherent fine porosity (such as diatomaceous earth) and the raw materials that result in interstices due to incomplete packing (such as talc) can may be increased or decreased to influence the fine pore size and thus also the ratio of fine to coarse pore size, such as shown in Examples 3-7 where the same diatomaceous earth, pore former, and talc ingredients are used but their respective amounts varied.

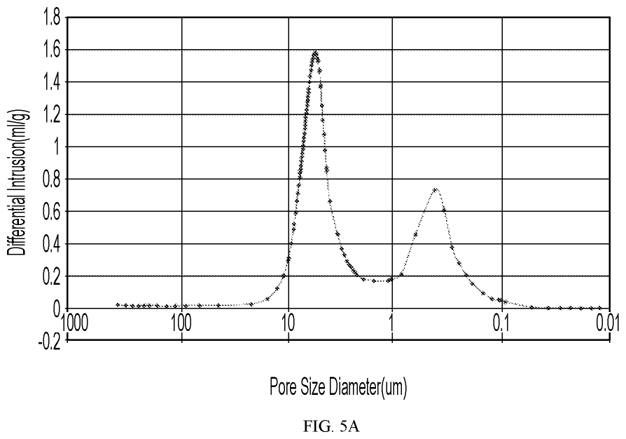

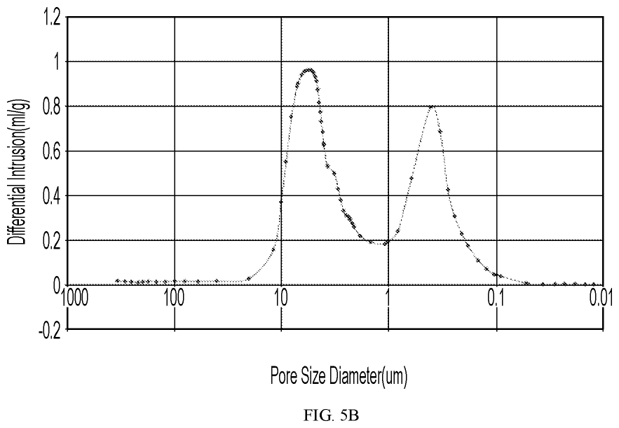

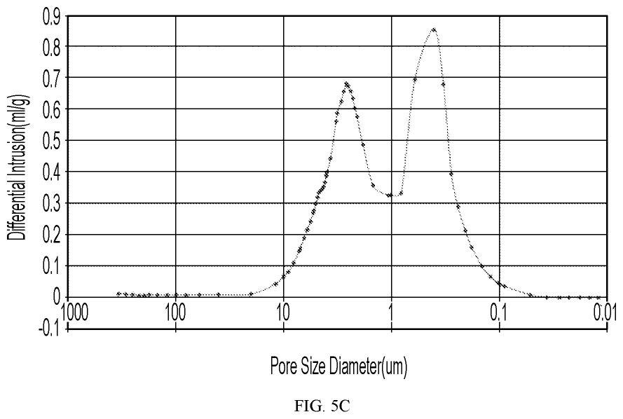

In Example 3, 50 wt % diatomaceous earth was used with respect to total inorganics in the mixture, with 40 wt % cross-linked pea starch superaddition prior to firing; Example 4 used 60 wt % diatomaceous earth, with 30 wt % cross-linked pea starch superaddition prior to firing; and Example 6 used 50 wt % diatomaceous earth was used, with 30 wt % cross-linked pea starch superaddition prior to firing. FIGS. 5A-C illustrate differential intrusion versus pore size distribution as measured during mercury porosimetry testing for fired ceramic monoliths. In particular, FIG. 5A illustrates the pore size distribution for Ex. 3, FIG. 5B illustrates the pore size distribution for Ex. 4, and FIG. 5C illustrates the pore size distribution for Ex. 6. Accordingly, FIGS. 5A-C show the influence of different levels of diatomaceous earth and cross-linked pea starch on the relative pore sizes of the coarse and fine distributions, with additional pore former (starch) addition tending to increase the size of the peak corresponding to the coarse pores and additional diatomaceous earth (having its own inherent porosity) tending to increase the size of the peak corresponding to the fine pores. In this way, the relative size of the first and second peaks (fine and coarse pores) can be influenced by adjusting the relative amounts of the raw materials that drive formation of each type of fine and coarse pores.

The choice of particulate material to provide the fine porosity as interstices resulting from the packing of the particles can also influence the ratio of coarse to fine pore size. For example, in contrast to Examples 3-7 that used a combination of diatomaceous earth and talc, Examples 8-15 used diatomaceous earth in combination with different secondary inorganic particulate materials, such as phlogopite (Examples 8A/8B and 12), fused silica (Examples 9 and 10), muscovite (Ex. 11), phlogopite (Ex. 12) and hollow glass microspheres (Examples 15 and 16).

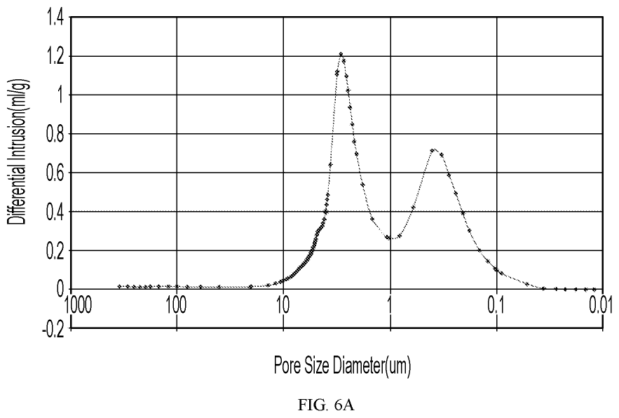

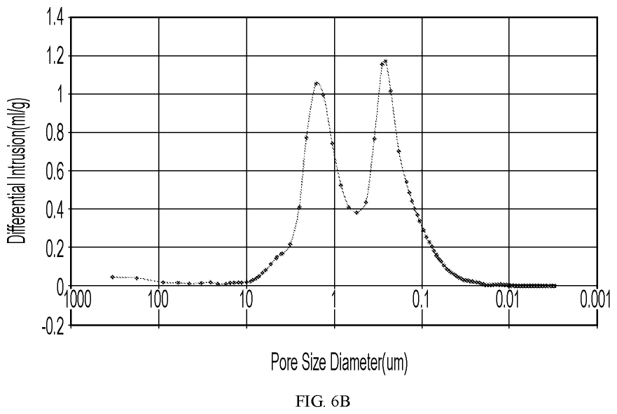

Different types of diatomaceous earth were also used to assess the effect derived from different diatomaceous earth morphologies shown in FIGS. 3A and 3B. For example, Examples 3-11, 13, and 15-16 used the diatomaceous earth from FIG. 3A, while Examples 2 and 12 used the diatomaceous earth from FIG. 3B, and Example 14 used a combination of both types. FIGS. 6A-B illustrate differential intrusion versus pore size distribution as measured during mercury porosimetry testing for the fired ceramic monoliths of Ex. 8B (Diafil 525 type diatomaceous earth particles) and Ex. 12 (“Celtix” type diatomaceous earth particles), respectively. The Celtix type diatomaceous earth material (e.g., see example particles in FIG. 3B) has a larger volume of fine pores within its particles than the Diafil 525 type diatomaceous earth material (e.g., see example particles in FIG. 3A) and therefore, the relative volume of fine porosity is observed to be higher for the monolith made in accordance with Ex. 12 (FIG. 6B) using the Celtix type material than that made in accordance with Ex. 8B (FIG. 6A) with the Diafil type material.

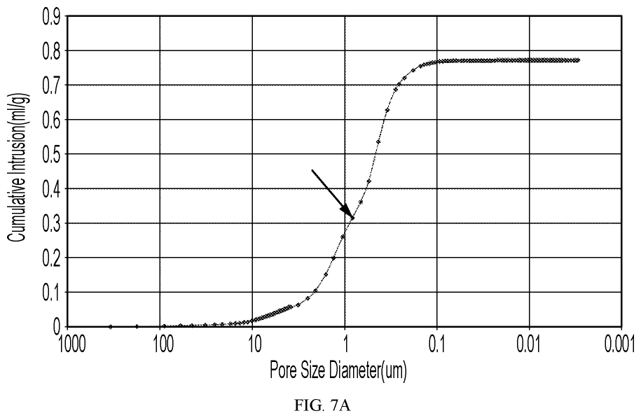

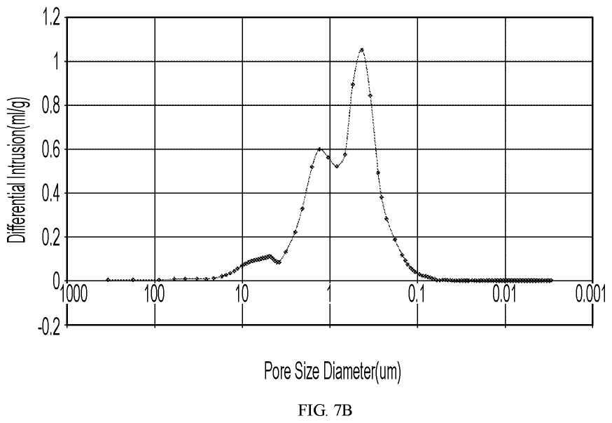

Multimodal pore size distributions having more than two peaks can also be created, such as trimodal distributions or distributions with a greater number of peaks. For example, in Ex. 14, a composition was formed that was a combination of both Diafil 525 and Celtix type diatomaceous earth particles, each at 40 wt %, which was added to 15.5% kaolin clay and 4.5 wt % sintering aid (4 wt % boric acid and 0.5 wt % K₂CO₃), all with respect to 100% inorganics in the mixture. To the composition was added 20 wt % superaddition of cross-linked pea starch, as well as water and the indicated organics. The composition was extruded into a green honeycomb body and fired at 950° C. for 4 hours. FIG. 7A illustrates cumulative intrusion versus pore size diameter of the substrate formed, and FIG. 7B illustrates differential intrusion versus pore size diameter of a substrate. In FIG. 7B, three peaks can be seen at approximately 5 μm, 1.5 μm, and 0.4 μm. In this trimodal Example, the dividing point between the definition of “coarse porosity” and “fine porosity” is the inflection point closest to 1 μm shown by the arrow in FIG. 7A.

Example 16 was unique in that it developed a bi-modal pore distribution without the use of an added organic pore former. Without wishing to be bound by theory, it appears that the hollow interiors of the hollow glass microsphere component contributed significantly to the coarse peak, while the inherent porosity of the diatomaceous earth particles contributed to the fine peak. Thus, Ex. 16 provides one example where burn out of an organic pore former is not required to obtain a coarse peak in the pore size distribution. Due to the absence of pore former in Ex. 16, the inorganic particulate matter (diatomaceous earth, hollow glass microspheres, talc, and clay) accounting for between about 95-96% of the total dry solids in this example.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present disclosure. Thus, it should be understood that although the present disclosure has been specifically described by specific aspects and optional features, modification and variation of the concepts herein disclosed may be resorted to by those of ordinary skill in the art, and that such modifications and variations are considered to be within the scope of aspects of the present invention.

### EXEMPLARY ASPECTS

The following exemplary aspects are provided, the numbering of which is not to be construed as designating levels of importance:

Aspect 1 provides a monolithic substrate comprising:
a ceramic and/or glass matrix comprising a continuous interconnected pore structure comprising first pores and second pores, wherein the first pores have a size of ≥0.1 micron to <1 micron and the second pores have a size of ≥1 micron to ≤30 microns, wherein the first pores and the second pores are each at least 5% of a total pore volume of the monolithic substrate, wherein the total pore volume of the monolithic substrate is greater than or equal to 40% by volume as determined by mercury porosimetry.

Aspect 2 provides the monolithic substrate of Aspect 1, wherein the first pores and second pores are homogeneously distributed throughout the ceramic and/or glass matrix.

Aspect 3 provides the monolithic substrate of any one of Aspects 1-2, wherein the monolithic substrate comprises a bimodal or trimodal size distribution.

Aspect 4 provides the monolithic substrate of any one of Aspects 1-3, wherein monolithic substrate has a cell density of 20 cells per square inch to 1000 cells per square inch and a wall thickness of 0.002 inches to 0.05 inches.

Aspect 5 provides the monolithic substrate of any one of Aspects 1-4, wherein the monolithic substrate has a bulk density of less than 1.5 g/cm³.

Aspect 6 provides the monolithic substrate of any one of Aspects 1-5, wherein the monolithic substrate has a bulk density of 0.5 g/cm³ to 1.15 g/cm³.

Aspect 7 provides the monolithic substrate of any one of Aspects 1-6, wherein the monolithic substrate has a bulk density of 0.6 g/cm³ to 0.8 g/cm³.

Aspect 8 provides the monolithic substrate of any one of Aspects 1-7, wherein the total pore volume of the monolithic substrate is 40% to 80% as determined by mercury porosimetry.

Aspect 9 provides the monolithic substrate of any one of Aspects 1-8, wherein the total pore volume of the monolithic substrate is 60% to 75% as determined by mercury porosimetry.

Aspect 10 provides the monolithic substrate of any one of Aspects 1-9, wherein the first pores have a local maximum differential intrusion as determined via mercury porosimetry at a pore size of 0.1 microns to 0.9 microns.

Aspect 11 provides the monolithic substrate of any one of Aspects 1-10, wherein the second pores have a local maximum differential intrusion as determined via mercury porosimetry at a pore size of 1.5 microns to 10 microns.

Aspect 12 provides the monolithic substrate of any one of Aspects 1-11, wherein the first pores are 10% to 94% of the total pore volume of the monolithic substrate.

Aspect 13 provides the monolithic substrate of any one of Aspects 1-12, wherein the first pores are 30% to 55% of the total pore volume of the monolithic substrate.

Aspect 14 provides the monolithic substrate of any one of Aspects 1-13, wherein the second pores are 6% to 90% of the total pore volume of the monolithic substrate.

Aspect 15 provides the monolithic substrate of Aspect 1-14, wherein the second pores are 40% to 85% of the total pore volume of the monolithic substrate.

Aspect 16 provides the monolithic substrate of any one of Aspects 1-15, wherein flexural strength in a 4-point bend test of the monolithic substrate normalized by CFA of the monolithic substrate is greater than 500 psi.

Aspect 17 provides the monolithic substrate of any one of Aspects 1-16, wherein flexural strength in a 4-point bend test of the monolithic substrate normalized by CFA of the monolithic substrate is 500 psi to 3000 psi.

Aspect 18 provides the monolithic substrate of any one of Aspects 1-17, wherein flexural strength in a 4-point bend test of the monolithic substrate normalized by CFA of the monolithic substrate is 1000 psi to 2600 psi.

Aspect 19 provides the monolithic substrate of any one of Aspects 1-18, wherein the monolithic substrate has a shape of a honeycomb form having a plurality of cells therein, the cells comprising parallel channels running longitudinally through the honeycomb form.

Aspect 20 provides the monolithic substrate of Aspect 19, wherein the honeycomb form has a circumferential profile of a circle, oval, square, rectangle, hexagon, triangle, polygon, or irregular shape.

Aspect 21 provides the monolithic substrate of any one of Aspects 19-20, wherein cells of the honeycomb form have a profile of a circle, oval, square, rectangle, hexagon, triangle, polygon, or irregular shape when viewed from an end of the honeycomb form.

Aspect 22 provides the monolithic substrate of any one of Aspects 1-21, further comprising a coating comprising a catalyst, a sorbent that adsorbs and desorbs CO₂, or a combination thereof, wherein the coating is directly adhered to the glass and/or ceramic matrix, wherein the monolithic substrate is free of an intervening bonding layer between the coating and the glass and/or ceramic matrix.

Aspect 23 provides the monolithic substrate of Aspect 22, wherein the bonding layer comprises a ceramic washcoat material.

Aspect 24 provides the monolithic substrate of any one of Aspects 22-23, wherein the bonding layer comprises gamma alumina, zeolite, activated carbon, or a combination thereof.

Aspect 25 provides the monolithic substrate of any one of Aspects 22-24, wherein the coating consists of the sorbent, the catalyst, or a combination thereof.

Aspect 26 provides the monolithic substrate of any one of Aspects 22-25, wherein the sorbent comprises a zeolite, sodium carbonate, activated carbon, carbon nanotubes, a metal-organic framework (MOF), an amine, or a combination thereof.

Aspect 27 provides a monolithic substrate comprising:
ceramic and/or glass matrix comprising a continuous interconnected pore structure comprising first pores and second pores, wherein the first pores have a size of ≥0.1 micron to <1 micron and a local maximum differential intrusion as determined via mercury porosimetry at a pore size of 0.1 microns to 0.9 microns, and the second pores have a size of ≥1 micron to ≤30 microns and a local maximum differential intrusion as determined via mercury porosimetry at a pore size of 1.5 microns to 10 microns, wherein the first pores are 10% to 94% of a total pore volume of the monolithic substrate and the second pores are 6% to 90% of the total pore volume, wherein the total pore volume of the monolithic substrate is greater than or equal to 60% to 75% by volume as determined by mercury porosimetry; and
a coating comprising a catalyst, a sorbent that adsorbs and desorbs CO₂, or a combination thereof, wherein the coating is directly adhered to the glass and/or ceramic matrix, wherein the monolithic substrate is free of a bonding layer between the coating and the glass and/or ceramic matrix.

Aspect 28 provides the monolithic substrate of any one of Aspects 1-27, wherein the monolithic substrate is an extruded, dried, and fired product of an extrudable composition, the extrudable composition comprising:
a binder and/or sintering aid; and
a particulate material for forming the first pores and that is stable to firing at a temperature of at least 600° C.

Aspect 29 provides the monolithic substrate of Aspect 28, wherein the particulate material for forming the first pores is stable to firing at a temperature of at least 950° C.

Aspect 30 provides the monolithic substrate of any one of Aspects 28-29, wherein the particulate material for forming the first pores is stable to firing at a temperature of at least 1100° C.

Aspect 31 provides the monolithic substrate of any one of Aspects 28-30, wherein the particulate material has a median particle diameter of 0.2 microns to 20 microns.

Aspect 32 provides the monolithic substrate of any one of Aspects 28-31, wherein the particulate material comprises a silicate, aluminate, oxide, glass, carbide, or combination thereof.

Aspect 33 provides the monolithic substrate of any one of Aspects 28-32, wherein the particulate material comprises diatomaceous earth, quartz, fused silica, cordierite, clay, talc, zeolite, spinel, wollastonite, mica, basalt, feldspar, aluminum oxide, glass powder, silicon carbide, or a combination thereof.

Aspect 34 provides the monolithic substrate of any one of Aspects 28-33, wherein the particulate material is 50 wt % to 90 wt % of the extrudable composition, based on a dry weight of the extrudable composition.

Aspect 35 provides the monolithic substrate of any one of Aspects 28-34, wherein the particulate material is 60 wt % to 80 wt % of the extrudable composition, based on a dry weight of the extrudable composition.

Aspect 36 provides the monolithic substrate of any one of Aspects 28-35, wherein the binder and/or sintering aid comprises an inorganic binder, a polymer, a thermosetting resin, a carbon precursor, a borate, a phosphate, a transition metal oxide, an oxide, a hydroxide, a carbonate, a silicate, an alumino-silicate, Fe₂O₃, boric acid, K₂CO₃, or a combination thereof.

Aspect 37 provides the monolithic substrate of any one of Aspects 28-36, wherein the binder and/or sintering aid is 1 wt % to 30 wt % of the extrudable composition, based on a dry weight of the extrudable composition.

Aspect 38 provides the monolithic substrate of any one of Aspects 28-37, wherein the binder and/or sintering aid is 2 wt % to 26 wt % of the extrudable composition, based on a dry weight of the extrudable composition.

Aspect 39 provides the monolithic substrate of any one of Aspects 28-38, wherein the binder and/or sintering aid comprises a crystalline or glassy structure.

Aspect 40 provides the monolithic substrate of any one of Aspects 28-39, wherein the extrudable composition further comprises a pore-forming material for forming the second pores.

Aspect 41 provides the monolithic substrate of Aspect 40, wherein the pore-forming material comprises a starch, a nut-shell flour, carbon, a natural polymer, a synthetic polymer, a carbonaceous material, crystalline carbon, amorphous carbon, or a combination thereof.

Aspect 42 provides the monolithic substrate of any one of Aspects 40-41, wherein the pore-forming material is 5 wt % to 45 wt % of the extrudable composition, based on a dry weight of the extrudable composition.

Aspect 43 provides the monolithic substrate of any one of Aspects 40-42, wherein the pore-forming material is 10 wt % to 35 wt % of the extrudable composition, based on a dry weight of the extrudable composition.

Aspect 44 provides the monolithic substrate of any one of Aspects 40-43, wherein the extrudable composition further comprises one or more solvents.

Aspect 45 provides a monolithic substrate comprising:
an extruded, dried, and fired product of an extruded extrudable composition, the extrudable composition comprising
   a binder and/or sintering aid; and
   a particulate material for forming the first pores and that is stable to firing at a temperature of at least 600° C.;
wherein the monolithic substrate comprises a ceramic and/or glass matrix comprising a continuous interconnected pore structure comprising first pores and second pores, wherein the first pores have a size of ≥0.1 micron to <1 micron and the second pores have a size of ≥1 micron to ≤30 microns, wherein the first pores and the second pores are each at least 5% of a total pore volume of the monolithic substrate, wherein the total pore volume of the monolithic substrate is greater than or equal to 40% by volume as determined by mercury porosimetry.

Aspect 46 provides a method of forming the monolithic substrate of any one of Aspects 28-45, the method comprising:
extruding the extrudable composition;
drying extruded composition; and
firing the dried extruded composition, to form the monolithic substrate.

Aspect 47 provides the method of Aspect 46, wherein the drying comprises heating and/or exposing to microwaves.

Aspect 48 provides the method of any one of Aspects 46-47, wherein the drying comprises placing the extruded composition under a vacuum.

Aspect 49 provides the method of any one of Aspects 46-48, wherein the drying comprises drying at a sufficient temperature and for a sufficient duration to substantially remove all solvent in the extruded composition.

Aspect 50 provides the method of any one of Aspects 46-49, wherein the firing comprises firing at 600° C. to 1100° C.

Aspect 51 provides the method of any one of Aspects 46-50, wherein the firing comprises firing at 750° C. to 950° C.

Aspect 52 provides the method of any one of Aspects 46-51, wherein the firing comprises firing for a duration of 1 h to 24 h.

Aspect 53 provides the method of any one of Aspects 46-52, wherein the firing comprises firing for a duration of 2 h to 6 h.

Aspect 54 provides the method of any one of Aspects 46-53, wherein the extrudable composition comprises pore-forming particles for forming the second pores, the firing is sufficient to pyrolyze and/or degrade the pore-forming particles to form the second pores.

Aspect 55 provides a method of forming a monolithic substrate, the method comprising:
extruding an extrudable composition, the extrudable composition comprising
   a binder and/or sintering aid; and
   a particulate material for forming first pores and that is stable to firing at a temperature of at least 600° C.;
drying extruded composition; and
firing the dried extruded composition, to form the monolithic substrate comprising
   ceramic and/or glass matrix comprising a continuous interconnected pore structure comprising the first pores and second pores, wherein the first pores have a size of ≥0.1 micron to <1 micron and the second pores have a size of ≥1 micron to ≤30 microns, wherein the first pores and the second pores are each at least 5% of a total pore volume of the monolithic substrate, wherein the total pore volume of the monolithic substrate is greater than or equal to 40% by volume as determined by mercury porosimetry.

Aspect 56 provides a method of using the monolithic substrate of any one of Aspects 22-26, the method comprising:
exposing the monolithic substrate to a gas stream including CO₂ to at least partially adsorb the CO₂ from the gas stream into the coating on the monolithic substrate; and
desorbing the CO₂ from the coating on the monolithic substrate.

Aspect 57 provides the monolithic substrate or method of any one or any combination of Aspects 1-56 optionally configured such that all elements or options recited are available to use or select from.

1. A monolithic substrate comprising:
a ceramic and/or glass matrix comprising a continuous interconnected pore structure comprising first pores and second pores, wherein the first pores have a size of ≥0.1 micron to <1 micron and the second pores have a size of ≥1 micron to ≤30 microns, wherein the first pores and the second pores are each at least 5% of a total pore volume of the monolithic substrate, wherein the total pore volume of the monolithic substrate is greater than or equal to 40% by volume as determined by mercury porosimetry.

2. The monolithic substrate of claim 1, wherein the monolithic substrate has a honeycomb form comprising a plurality of cells therein, the cells defining parallel channels running longitudinally through the honeycomb form.

3. The monolithic substrate of claim 1, wherein the monolithic substrate has a cell density of 20 cells per square inch to 1000 cells per square inch and a wall thickness of 0.002 inches to 0.05 inches.

4. The monolithic substrate of claim 1, wherein the monolithic substrate has a bulk density of 0.5 g/cm³ to 1.5 g/cm³, and wherein the total pore volume of the ceramic and/or glass matrix of the monolithic substrate is 40% to 80% as determined by mercury porosimetry.

5. The monolithic substrate of claim 1, wherein the first pores have a maximum differential intrusion as determined via mercury porosimetry at a pore size of 0.1 microns to 0.9 microns, and wherein the first pores are 10% to 94% of the total pore volume of the monolithic substrate.

6. The monolithic substrate of claim 1, wherein the second pores have a maximum differential intrusion as determined via mercury porosimetry at a pore size of 1.5 microns to 10 microns, and wherein the second pores are 6% to 90% of the total pore volume of the monolithic substrate.

7. The monolithic substrate of claim 1, wherein the first pores have a maximum differential intrusion as determined via mercury porosimetry at a pore size of ≥0.1 micron to <1 micron, the second pores have a maximum differential intrusion as determined via mercury porosimetry at a pore size of ≥1 micron to ≤30 microns, and wherein a difference between the maximum differential intrusion of the first pores and the second pores is ≥0.01 micron to ≤29.9 microns.

8. The monolithic substrate of claim 1, wherein flexural strength in a 4-point bend test of the monolithic substrate normalized by CFA of the monolithic substrate is 500 psi to 3000 psi.

9. The monolithic substrate of claim 1, wherein the monolithic substrate comprises a particulate material for forming the first pores, wherein particles of the particulate material are sintered together in the monolithic substrate and retain a shape of the particulate material within the monolithic substrate such that the first pores correspond to interstices between the particulate material.

10. The monolithic substrate of claim 9, wherein the particulate matter comprises from 30 wt % to 90% diatomaceous earth.

11. The monolithic substrate of claim 9, wherein the particulate material comprises diatomaceous earth in an amount of at least 35 wt %.

12. The monolithic substrate of claim 9, wherein the particulate material comprises diatomaceous earth in an amount of at least 50 wt %.

13. The monolithic substrate of claim 9, wherein the particulate material comprises diatomaceous earth in an amount of at least 75 wt %.

14. The monolithic substrate of claim 9, wherein the particulate material comprises talc in an amount of 10 wt % to 95 wt %.

15. The monolithic substrate of claim 9, wherein the particulate material comprises talc in an amount of at least 15 wt %.

16. The monolithic substrate of claim 9, wherein the particulate material comprises talc in an amount of at least 80 wt %.

17. The monolithic substrate of claim 9, wherein the particulate material comprises hollow glass microspheres in an amount of 30 wt % to 50 wt %.

18. The monolithic substrate of claim 9, wherein the particulate material comprises a combination of one or more of diatomaceous earth, talc, and hollow glass microspheres in a combined amount of 50 wt % to 95 wt %.

19. The monolithic substrate of claim 9, wherein the particulate material comprises a combination of one or more of diatomaceous earth, talc, and hollow glass microspheres in a combined amount of at least 75 wt %.

20. The monolithic substrate of claim 1, further comprising a coating comprising a catalyst, a sorbent that adsorbs and desorbs CO₂, or a combination thereof, wherein the coating is directly adhered to the glass and/or ceramic matrix, wherein the monolithic substrate is free of an intervening bonding layer between the coating and the glass and/or ceramic matrix.

21-34. (canceled)
